(19) United States
(12) Patent Application Publication
(10) Pub. No.: US 2015/0062925 A1
(43) Pub. Date: Mar. 5, 2015

(54) MULTI-PART REFLECTOR FOR OUTDOOR LIGHT DESIGN

(71) Applicant: GE Lighting Solutions, LLC, East Cleveland, OH (US)

(72) Inventors: Abby S. F. MOSHER, Mentor, OH (US); William H. BALHORN, Brecksville, OH (US); Xiaomei LOU, East Cleveland, OH (US); Mark J. MAYER, Sagamore Hills, OH (US); Matthew S. MRAKOVICH, East Cleveland, OH (US); Koushik Babi SAHA, Brunswick, OH (US)

(73) Assignee: GE Lighting Solutions, LLC, East Cleveland, OH (US)

(21) Appl. No.: 14/010,778

(22) Filed: Aug. 27, 2013

(51) Int. Cl. F21V 7/00

(52) U.S. Cl. CPC F21V 7/0025
USPC 362/346

(57) ABSTRACT

Provided is a reflector for an optical source including an elongated piece configured for reflecting light from the optical source onto a first reflective lighting zone. The reflector also includes at least two end-pieces connectable to respective ends of the elongated piece, each being configured to reflect the light onto second and third reflective lighting zones, respectively.

### I. TECHNICAL FIELD

The present invention relates generally to light fixture design. More particularly, the present invention relates to a multi-part reflector for a light fixture.

### II. BACKGROUND

Outdoor light fixtures typically include a light source, a lens, and/or a reflector. The reflector, lens, and any shielding typically define the light distribution pattern.

Highway and roadway lighting, for example, have historically used incandescent and, more recently, high intensity discharge (HID) lamps that can provide adequate amounts of light. HID lighting has several drawbacks, including frequent lamp maintenance or poor color performance. Many optical systems have badly designed reflectors that equate to poor control of the light.

This poorly controlled, light can be wasted in lighting areas around the roadway (and potentially, sidewalk) that do not require light. Poorly controlled light also contributes to trespass light and light pollution, which can interfere with the preservation of the nighttime environment. A major contributing factor to poorly controlled light relates to the optical system's reflector design.

Some light fixtures include a two piece reflector design, including a left reflector and a right reflector. Given the need for reflecting the light, most reflectors are manufactured using coating processes including physical vapor deposition process and chemical vapor deposition process. Because most of coating process relies on line-of-sight and sometimes the parts are orbitally rotated during the coating process, certain areas of the reflector can be “shaded” or blocked during the=coating process.

Manufacturing is also largely limited to coating process because an end portion of the reflectors is cup-shaped, i.e. has contours in multiple axes. Since the end portion is cup shaped, it's difficult to form pre-metalized materials into this shape without destroying the specular properties of the material.

### III. SUMMARY OF THE EMBODIMENTS

Given the aforementioned deficiencies, a need for a reflector design that addresses the issues and takes into account the considerations noted above.

In at least one embodiment, the present invention provides a reflector for an optical source. The reflector includes an elongated piece formed or configured for reflecting light from the optical source onto a first reflective lighting zone. The reflector also includes at least two end-pieces connectable to respective ends of the elongated piece, each being configured to reflect the light onto second and third reflective lighting zones, respectively.

Embodiments of the present invention provide a three piece optical reflector manufactured using improved manufacturing and coating techniques. The improvement occurs primarily because the deep cavities created in the two-piece design noted above, are eliminated. A three-piece design caters to the coating process and will easily allow for improved and more uniform coating on all of the optical surfaces including the elongated center portion.

A three-piece design also allows the flexibility to use multiple manufacturing methods and materials to achieve superior reflectivity of the elongated center section. These superior materials include, but are not limited to, pre-polished aluminum sheet metal commonly used in the industry. The three-piece design will also allow for flexibility in the optical platform. This is due to the interchangeable end-pieces and center pieces of the three-piece design.

Further features and advantages, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### IV. BRIEF DESCRIPTION OF THE DRAWINGS

Exemplary embodiments may take form in various components and arrangements of components. Exemplary embodiments are illustrated in the accompanying drawings, throughout which like reference numerals may indicate corresponding or similar parts in the various figures. The drawings are only for purposes of illustrating preferred embodiments and are not to be construed as limiting the invention. Given the following enabling description of the drawings, the novel aspects of the present invention should become evident to a person of ordinary skill in the art.

FIG. 1 is an illustration of a roadway optical platform in which embodiments of the present invention can be practiced.

FIG. 2 provides a more detailed illustration of LED array assemblies included in FIG. 1.

FIG. 3 is a more detailed illustration of the conventional two-part reflector assembly illustrated in FIG. 2.

FIG. 4 is an illustration of a reflective cavity in the conventional two-part reflector design of FIG. 3.

FIG. 5. is an illustration of a multi-part reflector design constructed in accordance with embodiments of the present invention.

FIG. 6 is an illustration a vacuum metallization chamber used in the manufacture of reflectors.

FIG. 7 is an illustration of a two end-piece pair design configured for use with a common centerpiece to provide different beam patterns in accordance with the embodiments.

FIGS. 8A and 8B illustrate views of a multi-part reflector design in accordance with a second embodiment of the present invention

FIG. 9 illustrates views of a multi-part reflector design in accordance with a third embodiment of the present invention.

### V. DETAILED DESCRIPTION OF THE EMBODIMENTS

While exemplary embodiments are described herein with illustrative embodiments for particular applications, it should be understood that the invention is not limited thereto. Those skilled in the art with access to the teachings provided herein will recognize additional modifications, applications, and embodiments within the scope thereof and additional fields in which the multi-reflector design described herein would be of significant utility.

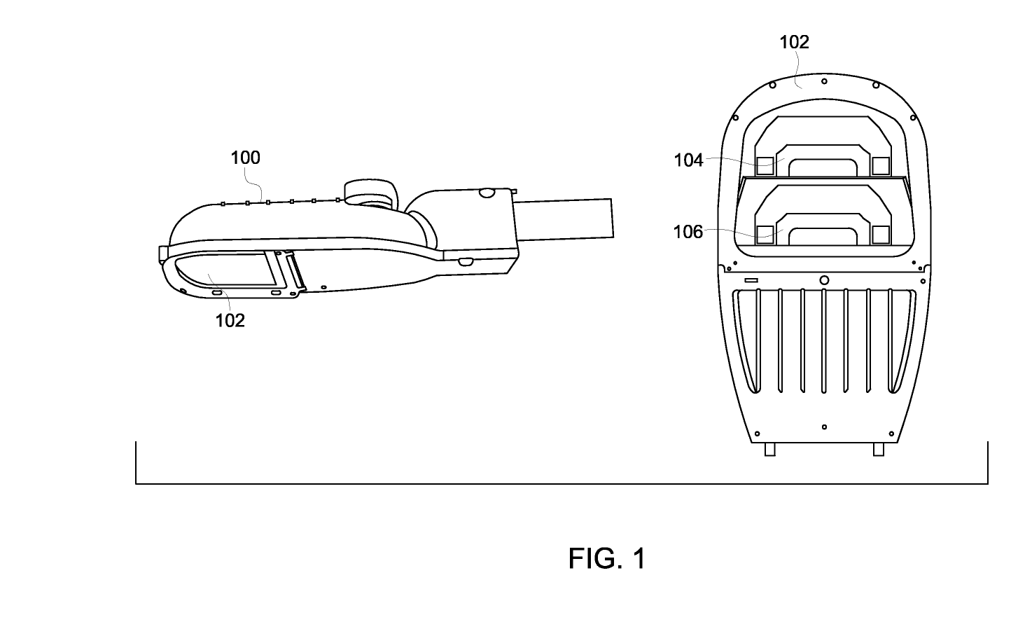

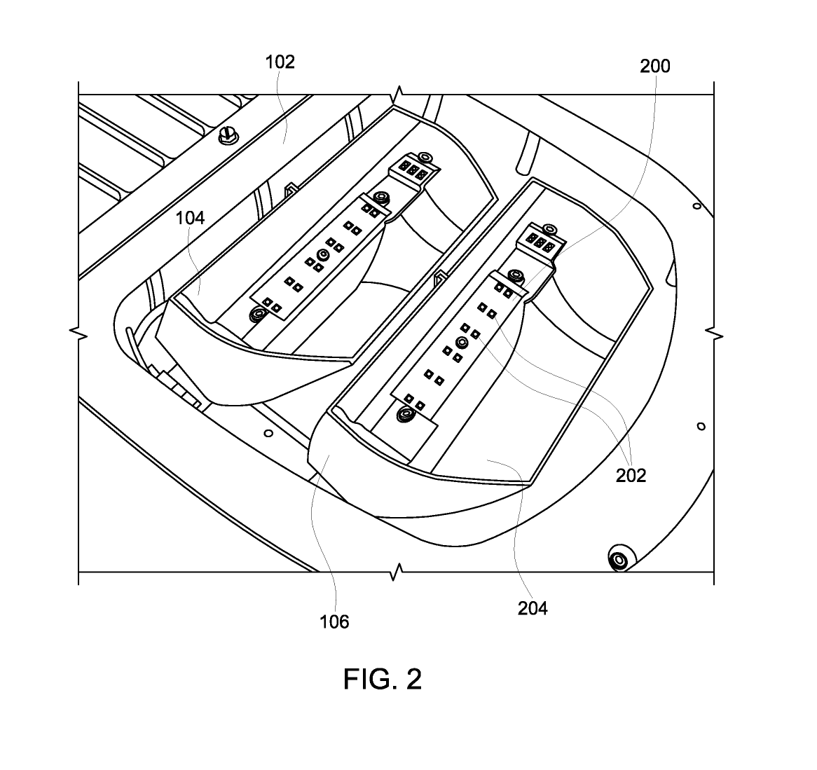

FIG. 1 is an illustration of a roadway optical platform 100 in which embodiments of the present invention can be practiced. The optical platform 100 is configured, for example, for use in a roadway streetlight system. The optical platform 100 has a lighting segment 102, including two LED light engine modules 104 and 106. FIG. 2 provides a more detailed illustration of the LED array light engine modules 104 and 106.

As illustrated in FIG. 2, each of the LED light engine module 104 and 106 includes an LED lighting array 200 comprised of a plurality of LEDs, such as LEDs 202. The LED lighting array 200 also includes a conventional two-piece reflector assembly 204 for reflecting and distriting light produced by the LEDs 202 across an area, such as the surface of a roadway.

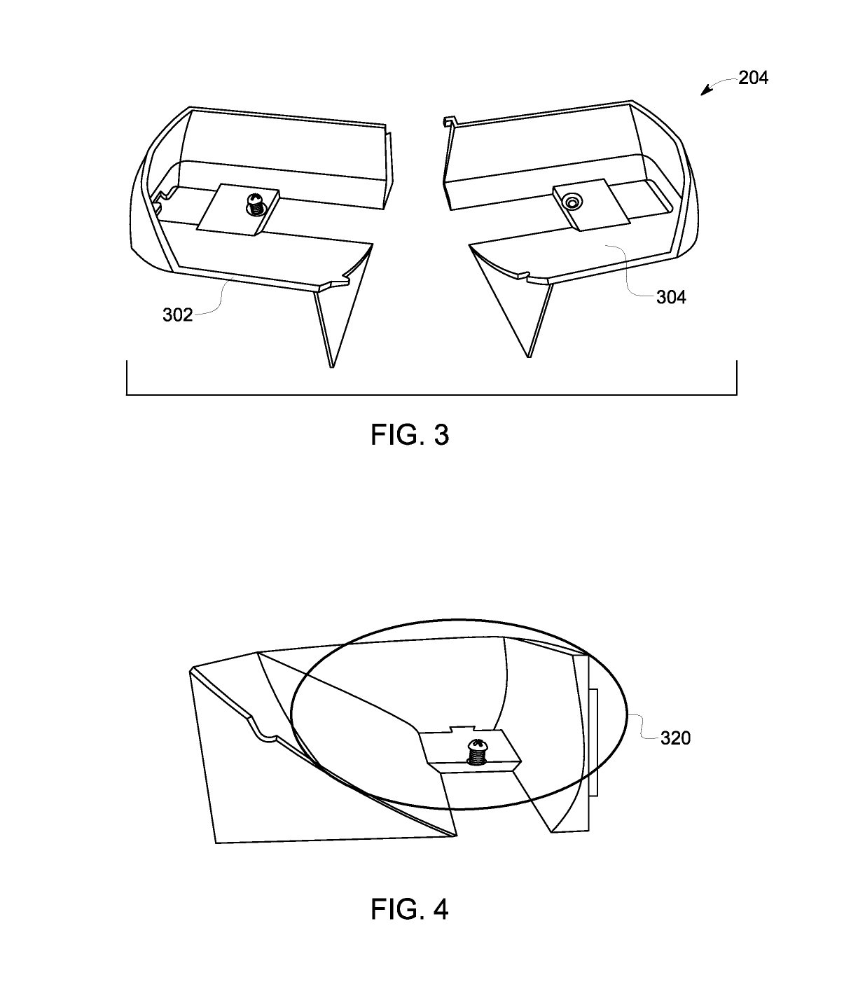

FIG. 3 is a more detailed illustration of the conventional two-piece reflector assembly 204 illustrated in FIG. 2. The two-piece reflector assembly 204 includes two portions 302 and 304. Due to the depth of the portions 302 and 304, a deep pocket 320 is formed in the corners, as depicted in FIG. 4. During the manufacture of this type of reflector, uneven reflective coating occurs in the reflective cavity 320. This uneven coating causes non-uniform reflection of light from the light source, such as the LEDs 202, ultimately resulting in non-uniform coverage of the light from the reflector.

By way of background, streetlights are configured to provide reflective lighting primarily in three different zones along a roadway. A first zone, for example, is referred to by those of skill in the art as Nadir: the area directly below the street light. In the case of roadways, for example, where a vehicle travels along the roadway at night, a second zone includes an area in the direction of the traveling vehicle (e.g., shinning away from a driver). A third zone includes light shining towards the driver, which is a vitally important aspect. These areas generally represent the three roadway reflective lighting zones.

The coating of the conventional two-part reflector design 204, due to the reflective cavity 320, provides suboptimal LED roadway lighting control. More specifically, the two-part reflector design 204 has severely limited ability to use the two portions 302 and 304 to provide predictive light reflectivity across the three roadway reflective lighting zones noted above.

Other conventional lighting systems use one or more small optics to illuminate all of the zones. These conventional lighting systems, however, do not provide significant control over the light going into the reflective zones, thus limiting their utility. Many of these conventional lighting systems use LEDs and can use, for example, one optic per LED. That is, if a conventional roadway lighting system uses 100 LEDs, this lighting system would include 100 clear plastic refractive optic segments. This approach, however, also provides suboptimal roadway lighting control.

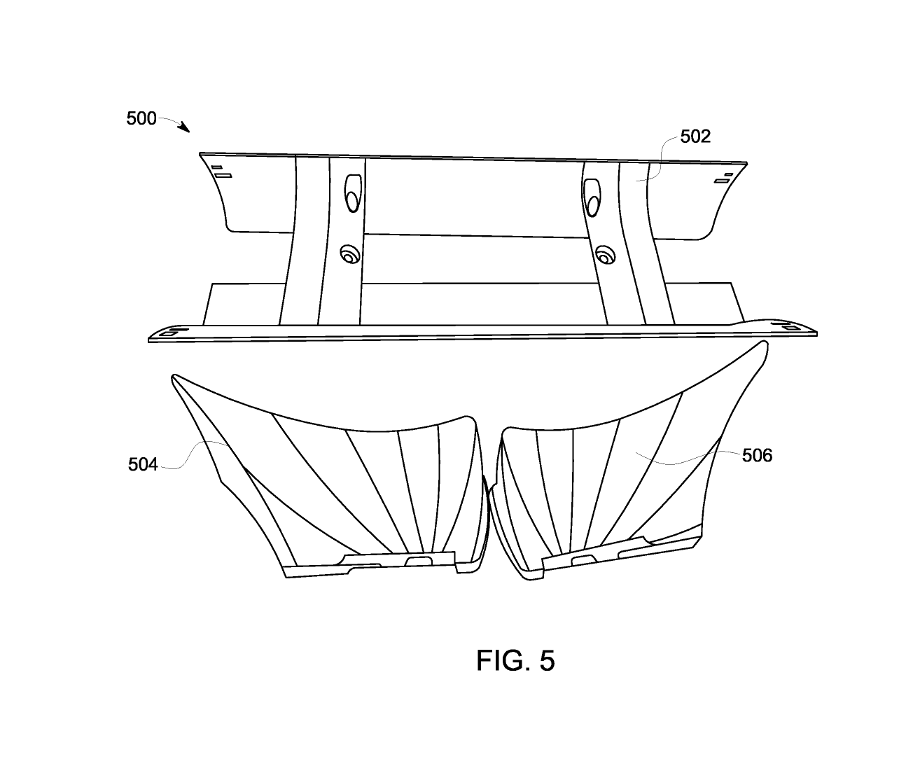

FIG. 5 is an illustration of a multi-part reflector design 500 constructed in accordance with embodiments of the present invention. The embodiments provide a multi-part reflector design 500 that enables the creation of uniform predictive reflectivity across each of the three roadway reflective lighting zones. A greater number of reflector portions, multi-part reflector 500, reduce the occurrence reflective cavities in each of the portions. Although the multi-part reflector design 500 depicts three portions, the present invention is not limited to only three portions.

In FIG. 5, the multi-part reflector 500 includes an elongated center portion 502, a left end-cap portion 504, and a right end-cap portion 506. In the illustrious embodiments, each of the three portions 502, 504, and 506 has a slightly less depth than the portions 302 and 304 of the two-part reflector design 300 of FIG. 3. Due to the slightly less depth, aluminum surfaces of the portions 502, 504, and 506 can be manufactured more uniformly during coating process because the three-piece design affords line of sight coating process.

By way of example, and not limitation, each of the portions 502, 504, and 506 of the multi-part reflector 500 reflects light in a different direction. Generally, for example, the elongated center portion 502 primarily reflects light into a first of the reflective lighting zones. More specifically, the elongated center portion 502 primarily directs light on Nadir, below the light fixture. The left end-piece 504 and right end-piece reflect light into the second and third of the reflective lighting zones.

In the manner described above, the multi-part reflector 500 enables the creation of uniform predictive reflectivity across the surfaces of the three roadway reflective lighting zones, as noted above. The two-piece reflectors in LED light engine module 104 and 106 of the roadway optical platform 100, for example, could be retrofitted with the multi-part reflector 500.

More particularly, each of the portions 502, 504, and 506 of the multi-part reflector 500 provides better optics to balance the light reflected across the three reflective lighting zones. That is, the multi-part reflector 500 provides better control and balancing of the surface light reflected toward a roadway driver (i.e., counter-beam), the light directed below the poll, and the light reflecting away from the driver (i.e., pro-beam). The ability to control light reflectivity of these different surfaces, produced by the streetlight, ultimately provides increased predictive results.

Increased predictability affects the total lumens produced by the light fixture and the distribution pattern of the light, which leads to more reliable efficiency calculations. The cost of LEDs is generally about 50% of the costs of entire lighting system. Increased predictability and efficiency results in lower electricity costs to the customer of the light since products can be reliably designed to produce greater lumens with fewer LEDs. This ultimately results in lower costs.

As noted above, the increased predictive results of the multi-part reflector 500 are due to the fact that the aluminum surfaces of the portions 502, 504, and 506 can be manufactured more uniformly during coating process. This process is explained in greater detail below.

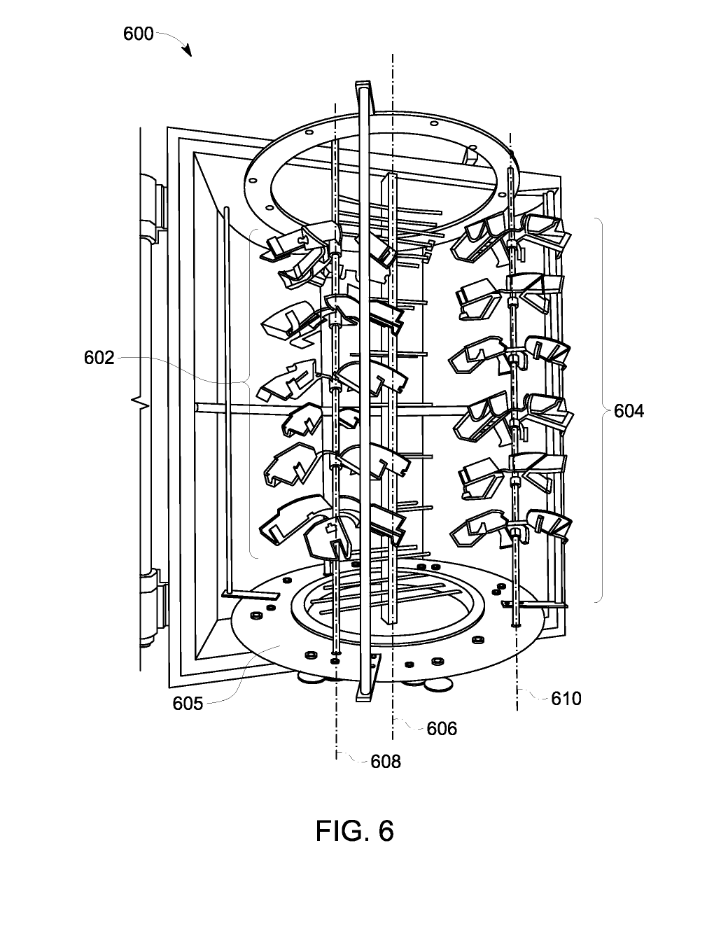

FIG. 6 is an illustration a thermal deposition chamber 600 used in the manufacture of the multi-part reflector 500 illustrated in FIG. 5. In FIG. 6, reflectors (not shown) are positioned within fixtures groups 602 and 604 to begin the coating process. The fixtures groups 602 and 604 are shown in the chamber 600 before a chamber door has been closed. During coating process, a round plate 605 spins around a center axis 606 of the chamber 600. The fixture groups 602 and 604, holding the reflectors, spin around axes 608 and 610 during the=coating process.

Each of the portions 502, 504, and 506 can be manufactured using, for example, an injection molding process, although the present invention is not so limited. The multi-part reflector 500 (e.g., constructed of plastic) is manufactured as the separate portions 502, 504, and 506 to reduce the occurrence of shaded areas, or reflective cavities that create non-uniformity. As a result of the multi-part design, more uniform coating can be achieved. Consequently, the multi-part reflector 500 performs more predictably with respect to the amount of light reflected across the surfaces of the three roadway reflective lighting zones.

By way of example, during coating process, each of the portions 502, 504, and 506 (e.g., positioned within a respective one of the fixtures within the groups 602 and 604) is rotated orbitally to provide optimal coverage and aluminum coating for all of the surfaces thereon. Because each of the portions 502, 504, and 506 is less deep, there are fewer shaded areas. As a result, during coating process, there is a reduced chance that a reflective cavity, such as the reflective deep cavity 320 of the two-piece reflector 300, can develop on any of the surfaces, or other areas, of the portions 502, 504, and 506. Since the reflector 500 is designed as three pieces, each of the pieces can be manufactured using different materials and manufacturing methods other than injection molding.

In one exemplary embodiment, with respect to other materials, a sheet-metal material can be used. For example, and not limitation, this sheet metal can be pre-coated with a highly specular reflective coating and can be used to construct the elongated center portion 502. The end-pieces could also be coated with an enhanced aluminum or could be silver coated with silver having a much higher reflectivity. For example, where normal aluminum coating might be on the order of 80 to 85% reflectivity, a silver coating could provide up to 95 to 98% reflectivity.

In the manner described above, the elongated center section 502 and the ends 504 and 506 can be constructed by mixing and matching different technologies beyond the single technology of injection molding and aluminum metallization.

Zinc die-cast is another suitable material that can be used with a type of reflective coating. This approach can help overcome the heat limitations associated with standard plastic portions, using some type of die-cast, whether zinc or aluminum. Although, the elongated center portion 502 can be manufactured from plastic or from die-cast, an advantage is afforded using the pre-metallized sheet-metal for the elongated portion 502. As noted above, the end-pieces 504 and 506 can be made from die-cast or plastic.

By way of example, and not limitation, glass could be used to construct the end-pieces 504 and 506. The glass can be coated using other types of coatings suitable for glass, but not suitable for coating sheet-metal or plastic. This process allows for use of sheet-metal for construction of the elongated center portion 502 and different materials for the end-pieces 504 and 506. An additional advantage provided by embodiments of the invention is described below.

Since the elongated center portion 502 and the end-pieces 504 and 506 are separate portions, the end-pieces 504 and 506 can be viewed as a single set. With the end-pieces 504 and 506 being seen as a single set, the multi-part reflector 500 can be viewed as having essentially two basic parts. A first of the two parts is the elongated centerpiece 502. The second part is the end-cap set 504/506. In this manner, the elongated centerpiece 502 can be paired with not only the end-cap set 504/506, but the elongated centerpiece 502 can be paired with other end-cap sets to provide different beam patterns.

With a single elongated centerpiece and an end-cap set, a design can be created that facilitates use of a common elongated centerpiece with different end-piece sets. Such an arrangement can be particularly applicable in situations where different roadways have different requirements and different pole spacings. For example, one street can have a 4-to-1 pole spacing, and another street can have a 6-to-1 pole spacing. As understood by those of skill in the art, pole spacing refers to the light pole spacing to the mounting height ratio.

By pairing different elongated center portions with different end-cap sets, one can optimize optical platforms for a specific spacing between the poles. For example, two different end-cap sets could be designed for two different respective roadways, using one common elongated centerpiece. The shape of the elongated centerpiece relates more to the road width and across the road uniformity, distribution, and control. More specifically, for example, the shape of the elongated centerpiece relates to how many lanes might require lighting. The shape of the end-cap sets has more to do with the spacing between the poles and down the road uniformity, distribution, and control.

Thus, a product can be created that can mix and match an elongated centerpiece with different end-cap sets. The elongated centerpiece more or less influences the projected shape of the ends. If a wider, or more narrow, centerpiece was provided, such a configuration would necessitate correspondingly, wider or more narrow end-pieces. On the other hand, if a roadway has a width of three lanes, with a centerpiece optimized for three lanes, one end-piece set could be used and configured for one pole spacing, and another end-cap set could be used and configured for another pole spacing.

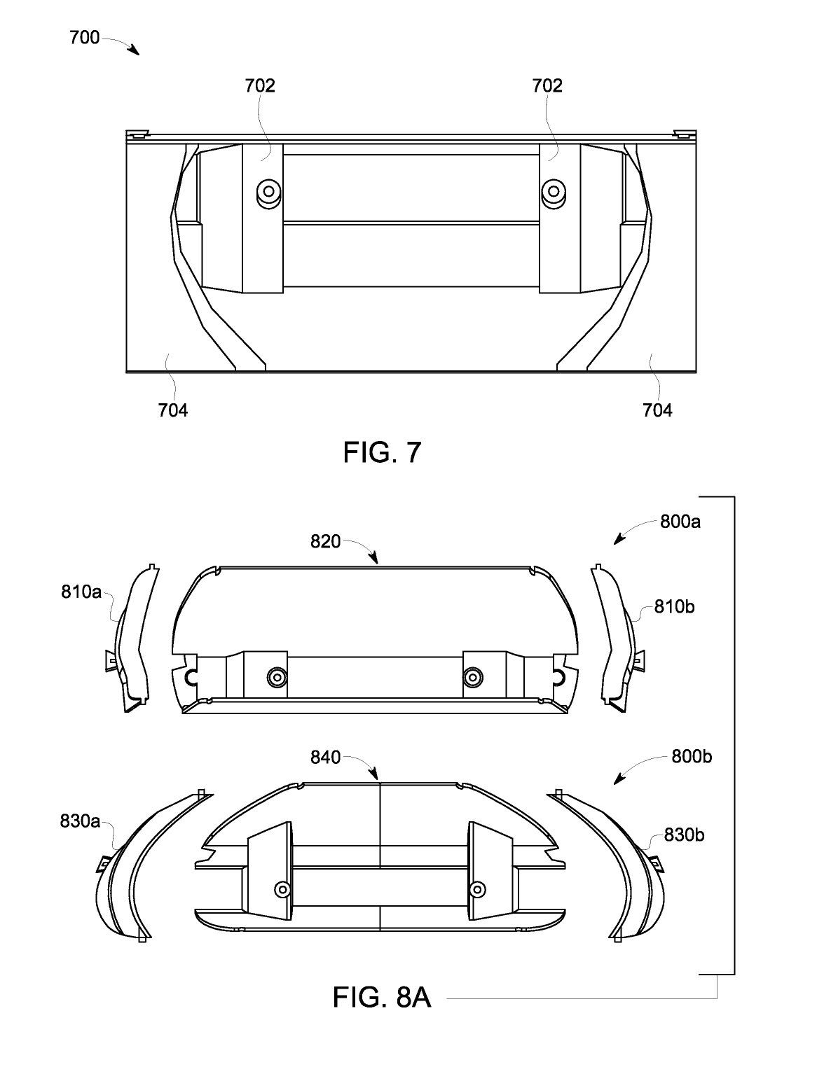

FIG. 7 is an illustration of a two end-cap design 700 (e.g., end-cap sets) configured for use with a common centerpiece, such as the elongated centerpiece 502, to provide different beam patterns. For example, a first end-cap pair 702 can be used with the elongated centerpiece 502 to produce a first beam pattern. A second end-cap pair 704 can be used with the elongated centerpiece 502 to provide a second beam pattern.

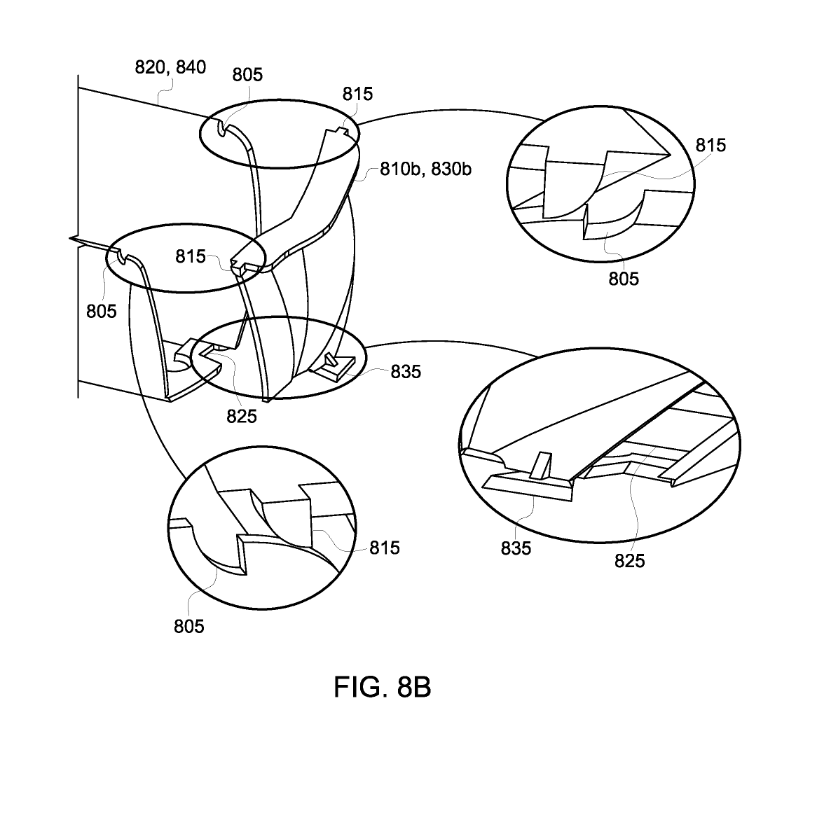

FIGS. 8A and 8B are illustrations of a multi-part reflector design in accordance with a second embodiment of the present invention.

Referring to FIG. 8A, a reflector 800A includes an elongated piece 820 and two end caps 810A and 810B. FIG. 8B illustrates a similar design in which a reflector 800B has an elongated piece 840 and end-pieces 830A and 830B. In both designs, the end-pieces slide in from the sides of the elongated piece 820. This is shown in more detail in FIG. 8B, which illustrates how end-pieces 810B and 830B are connected to the elongated portions 820 and 840, respectively. It should be appreciated that the end caps 810A and 830A may be connected to the elongated portions 820 and 840, respectively, in a similar manner.

Referring to FIG. 8B, the ends 810B and 830B have ridges 815 on the sides that snap into tabs 805 on the respective sides of the elongated pieces 820 and 840, respectively, locking the parts together. A dovetail 835 on the bottom of the ends 810B and 830B slides into an opening 825 on the elongated pieces 820 and 840, respectively.

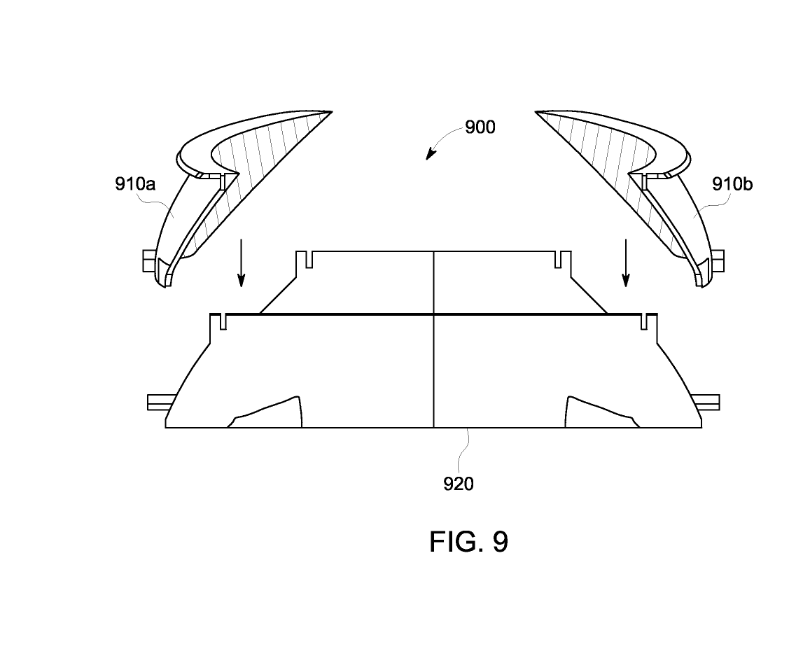

FIG. 9 is an illustration of a multi-part reflector design 900 in accordance with a third embodiment of the present invention. Referring to FIG. 9, the reflector 900 includes an elongated piece 920 and two ends 910A and 910B. In this design, the ends 910A and 910B slide into place from above the elongated piece 920.

Alternative embodiments, examples, and modifications which would still be encompassed by the invention may be made by those skilled in the art, particularly in light of the foregoing teachings. Further, it should be understood that the terminology used to describe the invention is intended to be in the nature of words of description rather than of limitation.

Those skilled in the art will also appreciate that various adaptations and modifications of the preferred and alternative embodiments described above can be configured without departing from the scope and spirit of the invention. Therefore, it is to be understood that, within the scope of the appended claims, the invention may be practiced other than as specifically described herein.

We claim:

1. A reflector for an optical source, comprising:
an elongated piece; and
at least two end-pieces connectable to respective ends of the elongated piece.

2. The reflector of claim 1, wherein the elongated centerpiece is configured for reflecting light from the optical source onto a first reflective lighting zone; and
wherein the at least two end-pieces are configured to reflect the light onto second and third reflective lighting zones, respectively.

3. The reflector of claim 1, wherein the elongated centerpiece is formed of a first material, and
wherein the end-pieces are formed of at least a second material.

4. The reflector of claim 1, wherein the elongated centerpiece is formed using a first manufacturing technique, and
wherein the end-pieces are formed using a second manufacturing technique.

5. The reflector of claim 4, wherein the elongated centerpiece is formed of sheet metal, and
wherein the end-pieces are formed of at least one from the group including glass and plastic.

6. The reflector of claim 1, wherein the elongated centerpiece and the end-pieces are formed from a same type material; and
wherein the elongated centerpiece and the end-pieces are devoid of deep pockets during.

7. A reflector for an optical source, comprising:
an elongated centerpiece;
wherein the centerpiece is configured for interchangeability with a plurality of end-piece pairs;
wherein the end-piece pairs relate primarily to down the road uniformity, distribution, and control; and
wherein the elongated centerpiece relates primarily to across the road uniformity, distribution, and control.

8. The reflector of claim 7, wherein the elongated centerpiece and the end-piece pairs are formed from a same type material; and
wherein the elongated centerpiece and the end-piece pairs are devoid of deep pockets.

9. The reflector of claim 7, wherein the elongated centerpiece is formed of sheet metal, and
wherein at least one of the end-piece pairs is formed of at least one from the group including cast metal, glass and plastic

10. The reflector of claim 7, wherein the elongated centerpiece is formed using a first manufacturing technique, and
wherein the end-piece pairs are formed using a second manufacturing technique.

11. The reflector of claim 7, wherein the elongated centerpiece is formed of a first material, and
wherein the end-piece pairs are formed of at least a second material.

12. A reflector for an optical source, comprising:
an elongated piece; and
at least two pairs of end-pieces connectable at respective ends of the elongated piece, wherein light from the optical source is reflected by the elongated piece and the end-pieces; and
wherein different reflection patterns are caused by reflection of the light from the elongated piece and each pair of the end-pieces.

13. The reflector of claim 12, wherein the elongated piece includes tabs into which respective top portions of the ends snap.

14. The reflector of claim 13, wherein the tabs are arranged along the side portions of the elongated piece.

15. The reflector of claim 14, wherein the top portion of each the end-pieces snap into the respective tabs by flexing of the side portions of the elongated piece.

16. A reflector for an optical source, comprising:
an elongated piece; and
at least one piece connectable at an end of the elongated piece, wherein light from the optical source is reflected by the elongated piece and the end-piece, and wherein the end-piece is formed by a different manufacturing process than the elongated piece, such a reflection pattern caused by reflection of the light from the elongated piece is different than a reflection pattern cause by reflection of the light from the end-piece.

17. The reflector of claim 16, further comprising at least another cap connectable at another end of the elongated piece, wherein light from the optical source is reflected by the elongated piece and the other cap, and wherein the other cap is formed by a different manufacturing process than the elongated piece, such a reflection pattern caused by reflection of the light from the elongated piece is different than a reflection pattern cause by reflection of the light from the other cap.

18. The reflector of claim 16, wherein the elongated piece comprises a tab into which a top portion of the cap snaps.

19. The reflector of claim 18, wherein the tab is arranged along a side portion of the elongated piece.

20. The reflector of claim 19, wherein the top portion of the cap snaps into the tab by flexing of the side portion of the elongated piece.

21. The reflector of claim 1, wherein the at least two end-pieces are mirror images of one another.

22. The reflector of claim 1, wherein one of the end-pieces if pro-beam and the other of the two end-pieces is counter-beam.
